(19) United States
(12) Patent Application Publication
(10) Pub. No.: US 2018/0144061 A1
(43) Pub. Date: May 24, 2018

(54) EDGE STORE DESIGNS FOR GRAPH DATABASES

(71) Applicant: LinkedIn Corporation, Sunnyvale, CA (US)

(72) Inventors: Andrew Rodriguez, Palo Alto, CA (US); Andrew J. Carter, Mountain View, CA (US); Scott M. Meyer, Berkeley, CA (US); Srinath Shankar, Mountain View, CA (US)

(73) Assignee: LinkedIn Corporation, Sunnyvale, CA (US)

(21) Appl. No.: 15/360,605

(22) Filed: Nov. 23, 2016

(51) Int. Cl. G06F 17/30

(52) U.S. Cl. CPC G06F 17/30958; G06F 17/30979; G06F 17/30949

(57) ABSTRACT

The disclosed embodiments provide a system for processing queries of a graph database. During operation, the system executes a set of processes for processing queries of a graph database storing a graph, wherein the graph comprises a set of nodes, a set of edges between pairs of nodes in the set of nodes, and a set of predicates. When a query of the graph database is received, the system performs a lookup of a hash map to obtain one or more offsets into an edge store for the graph database, which includes a one-linkage structure and a two-linkage structure. Next, the system accesses the offset(s) in the edge store to obtain a subset of the edges matching the query. The system then uses the subset of the edges to generate a result of the query and provides the result in a response to the query.

### RELATED APPLICATIONS

The subject matter of this application is related to the subject matter in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US).

The subject matter of this application is related to the subject matter in a co-pending non-provisional application by the same inventors as the instant application and filed on the same day as the instant application, entitled “Processing Deleted Edges in Graph Databases,” having serial number TO BE ASSIGNED, and filing date TO BE ASSIGNED (Attorney Docket No. LI-P2153.LNK.US).

### BACKGROUND

### Field

The disclosed embodiments relate to graph databases. More specifically, the disclosed embodiments relate to edge store designs for graph databases.

### Related Art

Data associated with applications is often organized and stored in databases. For example, in a relational database data is organized based on a relational model into one or more tables of rows and columns, in which the rows represent instances of types of data entities and the columns represent associated values. Information can be extracted from a relational database using queries expressed in a Structured Query Language (SQL).

In principle, by linking or associating the rows in different tables, complicated relationships can be represented in a relational database. In practice, extracting such complicated relationships usually entails performing a set of queries and then determining the intersection of or joining the results. In general, by leveraging knowledge of the underlying relational model, the set of queries can be identified and then performed in an optimal manner.

However, applications often do not know the relational model in a relational database. Instead, from an application perspective, data is usually viewed as a hierarchy of objects in memory with associated pointers. Consequently, many applications generate queries in a piecemeal manner, which can make it difficult to identify or perform a set of queries on a relational database in an optimal manner. This can degrade performance and the user experience when using applications.

Various approaches have been used in an attempt to address this problem, including using an object-relational mapper, so that an application effectively has an understanding or knowledge about the relational model in a relational database. However, it is often difficult to generate and to maintain the object-relational mapper, especially for large, real-time applications.

Alternatively, a key-value store (such as a NoSQL database) may be used instead of a relational database. A key-value store may include a collection of objects or records and associated fields with values of the records. Data in a key-value store may be stored or retrieved using a key that uniquely identifies a record. By avoiding the use of a predefined relational model, a key-value store may allow applications to access data as objects in memory with associated pointers (i.e., in a manner consistent with the application's perspective). However, the absence of a relational model means that it can be difficult to optimize a key-value store. Consequently, it can also be difficult to extract complicated relationships from a key-value store (e.g., it may require multiple queries), which can also degrade performance and the user experience when using applications.

### BRIEF DESCRIPTION OF THE FIGURES

FIG. 1 shows a schematic of a system in accordance with the disclosed embodiments.

FIG. 2 shows a graph in a graph database in accordance with the disclosed embodiments.

FIG. 3 shows an index structure for a graph database in accordance with the disclosed embodiments.

FIG. 4 shows an exemplary index structure for a graph database in accordance with the disclosed embodiments.

FIG. 5 shows an exemplary set of pages in an edge store for a graph database in accordance with the disclosed embodiments.

FIG. 6 shows a flowchart illustrating the process of providing an index to a graph database in accordance with the disclosed embodiments.

FIG. 7 shows a flowchart illustrating the process of accessing an edge store for a graph database in accordance with the disclosed embodiments.

FIG. 8 shows a flowchart illustrating the processing of a query of a graph database in accordance with the disclosed embodiments.

FIG. 9 shows a flowchart illustrating the process of using an edge store of a graph database to resolve a query of the graph database in accordance with the disclosed embodiments.

FIG. 10 shows a computer system in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor that executes a particular software module or a piece of code at a particular time, and/or other programmable-logic devices now known or later developed. When the hardware modules or apparatus are activated, they perform the methods and processes included within them.

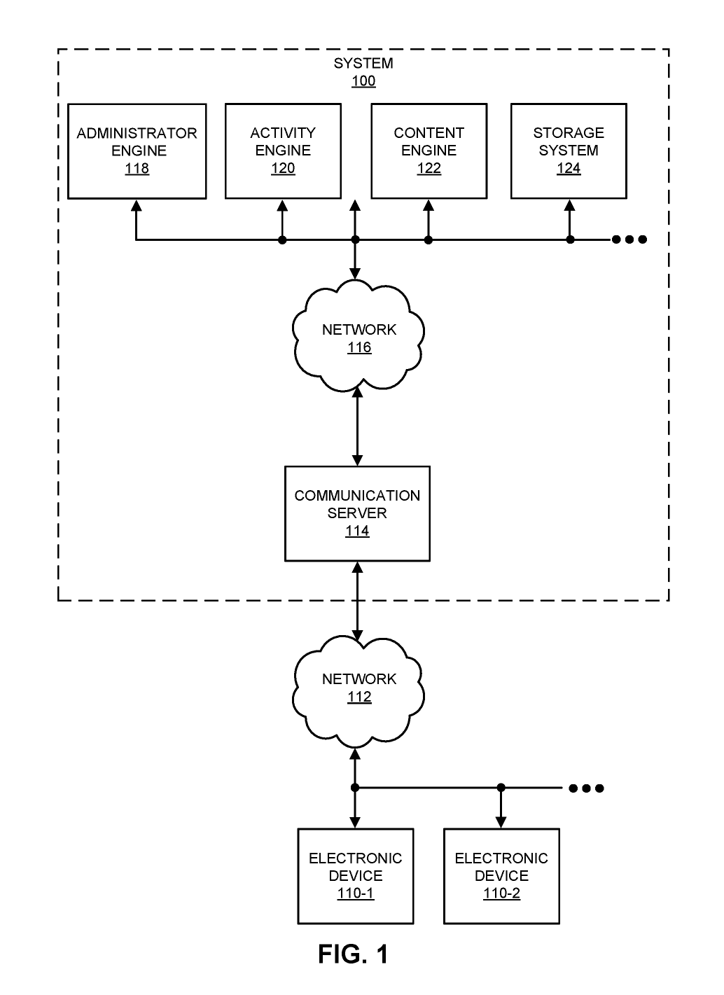

The disclosed embodiments provide a method, apparatus and system for processing queries of a graph database. A system 100 for performing a graph-storage technique is shown in FIG. 1. In this system, users of electronic devices 110 may use a service that is, at least in part, provided using one or more software products or applications executing in system 100. As described further below, the applications may be executed by engines in system 100.

Moreover, the service may, at least in part, be provided using instances of a software application that is resident on and that executes on electronic devices 110. In some implementations, the users may interact with a web page that is provided by communication server 114 via network 112, and which is rendered by web browsers on electronic devices 110. For example, at least a portion of the software application executing on electronic devices 110 may be an application tool that is embedded in the web page, and that executes in a virtual environment of the web browsers. Thus, the application tool may be provided to the users via a client-server architecture.

The software application operated by the users may be a standalone application or a portion of another application that is resident on and that executes on electronic devices 110 (such as a software application that is provided by communication server 114 or that is installed on and that executes on electronic devices 110).

A wide variety of services may be provided using system 100. In the discussion that follows, a social network (and, more generally, a network of users), such as an online professional network, which facilitates interactions among the users, is used as an illustrative example. Moreover, using one of electronic devices 110 (such as electronic device 110-1) as an illustrative example, a user of an electronic device may use the software application and one or more of the applications executed by engines in system 100 to interact with other users in the social network. For example, administrator engine 118 may handle user accounts and user profiles, activity engine 120 may track and aggregate user behaviors over time in the social network, content engine 122 may receive user-provided content (audio, video, text, graphics, multimedia content, verbal, written, and/or recorded information) and may provide documents (such as presentations, spreadsheets, word-processing documents, web pages, etc.) to users, and storage system 124 may maintain data structures in a computer-readable memory that may encompass multiple devices, i.e., a large-scale distributed storage system.

Note that each of the users of the social network may have an associated user profile that includes personal and professional characteristics and experiences, which are sometimes collectively referred to as ‘attributes’ or ‘characteristics.’ For example, a user profile may include demographic information (such as age and gender), geographic location, work industry for a current employer, an employment start date, an optional employment end date, a functional area (e.g., engineering, sales, consulting), seniority in an organization, employer size, education (such as schools attended and degrees earned), employment history (such as previous employers and the current employer), professional development, interest segments, groups that the user is affiliated with or that the user tracks or follows, a job title, additional professional attributes (such as skills), and/or inferred attributes (which may include or be based on user behaviors).

Moreover, user behaviors may include log-in frequencies, search frequencies, search topics, browsing certain web pages, locations (such as IP addresses) associated with the users, advertising or recommendations presented to the users, user responses to the advertising or recommendations, likes or shares exchanged by the users, interest segments for the likes or shares, and/or a history of user activities when using the social network. Furthermore, the interactions among the users may help define a social graph in which nodes correspond to the users and edges between the nodes correspond to the users' interactions, interrelationships, and/or connections. However, as described further below, the nodes in the graph stored in the graph database may correspond to additional or different information than the members of the social network (such as users, companies, etc.). For example, the nodes may correspond to attributes, properties or characteristics of the users.

As noted previously, it may be difficult for the applications to store and retrieve data in existing databases in storage system 124 because the applications may not have access to the relational model associated with a particular relational database (which is sometimes referred to as an ‘object-relational impedance mismatch’). Moreover, if the applications treat a relational database or key-value store as a hierarchy of objects in memory with associated pointers, queries executed against the existing databases may not be performed in an optimal manner. For example, when an application requests data associated with a complicated relationship (which may involve two or more edges, and which is sometimes referred to as a ‘compound relationship’), a set of queries may be performed and then the results may be linked or joined. To illustrate this problem, rendering a web page for a blog may involve a first query for the three-most-recent blog posts, a second query for any associated comments, and a third query for information regarding the authors of the comments. Because the set of queries may be suboptimal, obtaining the results may be time-consuming. This degraded performance may, in turn, degrade the user experience when using the applications and/or the social network.

In order to address these problems, storage system 124 may include a graph database that stores a graph (e.g., as part of an information-storage-and-retrieval system or engine). Note that the graph may allow an arbitrarily accurate data model to be obtained for data that involves fast joining (such as for a complicated relationship with skew or large ‘fan-out’ in storage system 124), which approximates the speed of a pointer to a memory location (and thus may be well suited to the approach used by applications).

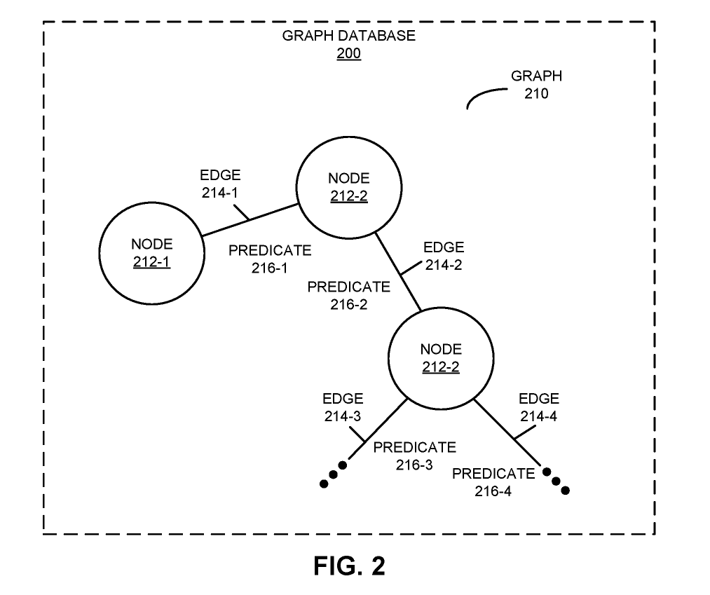

FIG. 2 presents a block diagram illustrating a graph 210 stored in a graph database 200 in system 100 (FIG. 1). Graph 210 includes nodes 212, edges 214 between nodes 212, and predicates 216 (which are primary keys that specify or label edges 214) to represent and store the data with index-free adjacency, i.e., so that each node 212 in graph 210 includes a direct edge to its adjacent nodes without using an index lookup.

Each edge in graph 210 may be specified in a (subject, predicate, object) triple. For example, an edge denoting a connection between two members named “Alice” and “Bob” may be specified using the following statement:

Edge(“Alice”, “ConnectedTo”, “Bob”)

In the above statement, “Alice” is the subject, “Bob” is the object, and “ConnectedTo” is the predicate.

In addition, specific types of edges and/or more complex structures in graph 210 may be defined using schemas. Continuing with the previous example, a schema for employment of a member at a position within a company may be defined using the following:
DefPred(“Position/company”, “1”, “node”, “0”, “node”).
DefPred(“Position/member”, “1”, “node”, “0”, “node”).
DefPred(“Position/start”, “1”, “node”, “0”, “date”).
DefPred(“Position/end_date”, “1”, “node”, “0”, “date”).
M2C(positionId, memberId, companyId, start, end):—
   Edge(positionId, “Position/member”, memberId),
   Edge(positionId, “Position/company”, companyId),
   Edge(positionId, “Position/start”, start),
   Edge(positionId, “Position/end_date”, end)

In the above schema, the employment is represented by four predicates, followed by a rule with four edges that use the predicates. The predicates include a first predicate representing the position at the company (e.g., “Position/company”), a second predicate representing the position of the member (e.g., “Position/member”), a third predicate representing a start date at the position (e.g., “Position/start”), and a fourth predicate representing an end date at the position (e.g., “Position/end_date”). In the rule, the first edge uses the second predicate to specify a position represented by “positionId” held by a member represented by “memberId,” and the second edge uses the first predicate to link the position to a company represented by “companyId.” The third edge of the rule uses the third predicate to specify a “start” date of the member at the position, and the fourth edge of the rule uses the fourth predicate to specify an “end” date of the member at the position.

Graph 210 and the associated schemas may additionally be used to populate graph database 200 for processing of queries against the graph. More specifically, a representation of nodes 212, edges 214, and predicates 216 may be obtained from a source of truth, such as a relational database, distributed filesystem, and/or other storage mechanism, and stored in a log in the graph database. Lock-free access to the graph database may be implemented by appending changes to graph 210 to the end of the log instead of requiring modification of existing records in the source of truth. In turn, the graph database may provide an in-memory cache of the log and an index for efficient and/or flexible querying of the graph.

In other words, nodes 212, edges 214, and predicates 216 may be stored as offsets in a log that is read into memory in graph database 200. For example, the exemplary edge statement for creating a connection between two members named “Alice” and “Bob” may be stored in a binary log using the following format:
256 Alice
261 Bob
264 ConnectedTo
275 (256, 264, 261)
   In the above format, each entry in the log is prefaced by a numeric (e.g., integer) offset representing the number of bytes separating the entry from the beginning of the log. The first entry of “Alice” has an offset of 256, the second entry of “Bob” has an offset of 261, and the third entry of “ConnectedTo” has an offset of 264. The fourth entry has an offset of 275 and stores the connection between “Alice” and “Bob” as the offsets of the previous three entries in the order in which the corresponding fields are specified in the statement used to create the connection (i.e., Edge(“Alice”, “ConnectedTo”, “Bob”)).

Because the ordering of changes to graph 210 is preserved in the log, offsets in the log may be used as identifiers for the changes. Continuing with the previous example, the offset of 275 may be used as a unique identifier for the edge representing the connection between “Alice” and “Bob.” The offsets may additionally be used as representations of virtual time in the graph. More specifically, each offset in the log may represent a different virtual time in the graph, and changes in the log up to the offset may be used to establish a state of the graph at the virtual time. For example, the sequence of changes from the beginning of the log up to a given offset that is greater than 0 may be applied, in the order in which the changes were written, to construct a representation of the graph at the virtual time represented by the offset.

Note that graph database 200 may be an implementation of a relational model with constant-time navigation, i.e., independent of the size N, as opposed to varying as log(N). Furthermore, a schema change in graph database 200 (such as the equivalent to adding or deleting a column in a relational database) may be performed with constant time (in a relational database, changing the schema can be problematic because it is often embedded in associated applications). Additionally, for graph database 200, the result of a query may be a subset of graph 210 that maintains the structure (i.e., nodes, edges) of the subset of graph 210.

The graph-storage technique may include embodiments of methods that allow the data associated with the applications and/or the social network to be efficiently stored and retrieved from graph database 200. Such methods are described in a co-pending non-provisional application by inventors Srinath Shankar, Rob Stephenson, Andrew Carter, Maverick Lee and Scott Meyer, entitled “Graph-Based Queries,” having Ser. No. 14/858,178, and filing date Sep. 18, 2015 (Attorney Docket No. LI-P1664.LNK.US), which is incorporated herein by reference.

Referring back to FIG. 1, the graph-storage techniques described herein may allow system 100 to efficiently and quickly (e.g., optimally) store and retrieve data associated with the applications and the social network without requiring the applications to have knowledge of a relational model implemented in graph database 200. For example, graph database 200 may be configured to store data associated with a variety of flexible schemas using edges representing subjects, objects, and predicates in the graph. Consequently, the graph-storage techniques may improve the availability and the performance or functioning of the applications, the social network and system 100, which may reduce user frustration and which may improve the user experience. Therefore, the graph-storage techniques may increase engagement with or use of the social network, and thus may increase the revenue of a provider of the social network.

Note that information in system 100 may be stored at one or more locations (i.e., locally and/or remotely). Moreover, because this data may be sensitive in nature, it may be encrypted. For example, stored data and/or data communicated via networks 112 and/or 116 may be encrypted.

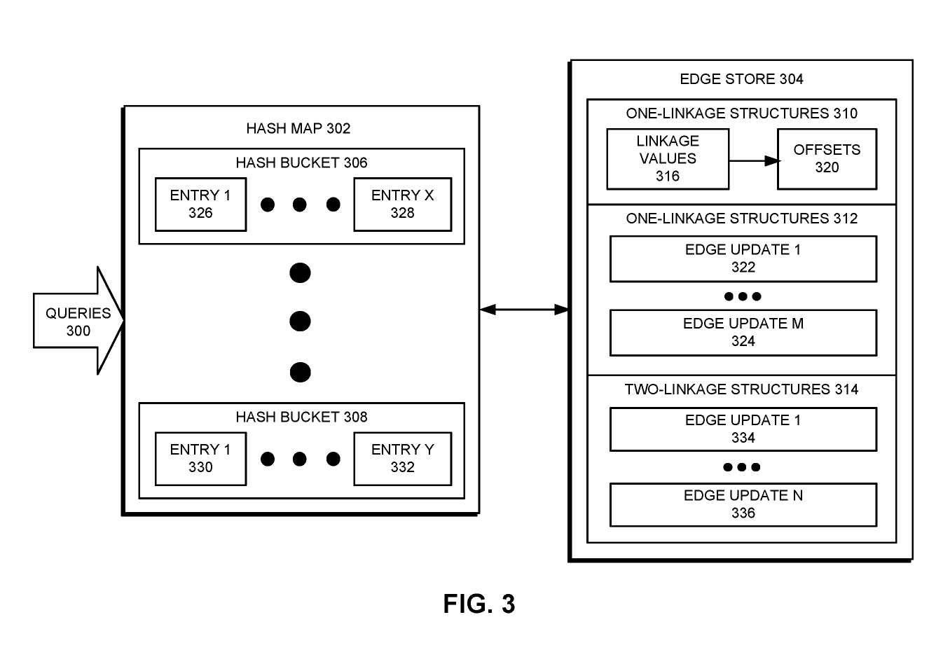

The graph database may also include an in-memory index structure that enables efficient lookup of edges 214 of graph 210 by subject, predicate, object, and/or other keys or parameters. As shown in FIG. 3, the index structure may include a hash map 302 and an edge store 304 for use in processing queries 300 of graph database 200. Hash map 302 and edge store 304 may be accessed simultaneously by a number of processes, including a single write process and multiple read processes. In turn, the processes may read from the index structure, write to the index structure, and/or process deleted edges using the index structure, as described in further detail below.

Hash map 302 may include a set of fixed-size hash buckets 306-308, each of which contains a set of fixed-size entries (e.g., entry 1 326, entry x 328, entry 1 330, entry y 332). Each entry in the hash map may include one or more keys and one or more values associated with the key(s). The keys may include attributes by which the graph database is indexed, and the values may represent attributes in the graph database that are associated with the keys. For example, the keys may be subjects, predicates, and/or objects that partially define edges in the graph, and the values may include offsets into edge store 304 that are used to resolve the edges.

A hash bucket may also include a reference to an overflow bucket containing additional hash table entries with the same hash as the hash bucket. While the hash bucket has remaining capacity, the hash bucket may omit a reference to any overflow buckets. When the remaining capacity of the hash bucket is consumed by entries in the hash bucket, an overflow bucket is instantiated in the hash table, additional entries are stored in the overflow bucket, and a reference to the overflow table is stored in a header and/or an entry in the hash bucket.

When a query of the graph database is received, a key in the query may be matched to an entry in hash map 302, and an offset in the entry is used to retrieve the corresponding edges from edge store 304. For example, the key may include a subject, predicate, object, and/or other attribute associated with the edges. A hash of the key may be used to identify a hash bucket in hash map 302, and another hash of the key may be used to identify the corresponding entry in the hash bucket. Because the hash buckets and entries are of fixed size, a single calculation (e.g., a first hash of the key modulo the number of has buckets+a second hash of the key modulo the number of entries in each hash bucket) may be used to identify the offset or address of the corresponding entry in the hash map. In turn, the same entry may be reused to store a different fixed-size value instead of requiring the creation of another entry in the hash bucket to store the fixed-size value.

An offset into edge store 304 may be obtained from the entry and used to retrieve and/or modify a set of edges matching the query from the edge store. More specifically, edge store 304 may include two types of one-linkage structures 310-312, as well as one or more two-linkage structures 314. One-linkage structures 310-312 and two-linkage structures 314 may be tables and/or other types of data structures for storing records containing edge information in the graph database. Each one-linkage structure may specify one linkage (e.g., subject, predicate, or object) in a corresponding edge in edge store 304, and each two-linkage structure may specify two linkages in the corresponding edge in edge store 304. In other words, a linkage may be a subject, predicate, object, and/or other single attribute of an edge in the graph database.

Two-linkage structures 314 may include a set of edge updates (e.g., edge update 1 334, edge update n 336) that can be used to process the query. For example, edge updates in one or more two-linkage structures 314 may be read to retrieve a set of edges in response to a read query of the graph database. In another example, edge updates may be added to one or more two-linkage structures 314 in response to a write query of the graph database. Within two-linkage structures 314, edge updates may store and/or specify two linkages out of three or more linkages that define the edges.

One-linkage structures 310 may map from linkage values 316 of one linkage (e.g., subject, predicate, or object) in the edges to one or more additional offsets 320 in one-linkage structures 312 that can be used to resolve the edges. In turn, offsets into one-linkage structures 312 may be used to retrieve edge updates (e.g., edge update 1 322, edge update m 324) that are used to resolve the edges. For example, edge updates in one-linkage structures 312 may specify values of an object for a subject that is indexed in hash map 302 and a predicate that is specified in linkage values 316 of one-linkage structures 310.

Because two-linkage structures 314 are not further filtered or sorted by additional linkages in the edges, two-linkage structures 314 may be used to store small sets of edges for a given first linkage value. On the other hand, larger sets of edges for a given first linkage value may be managed using one-linkage structures 310 that point to one-linkage structures 312, thus allowing for filtering of the edge sets by the first linkage value and a second linkage value. As a result, edges may be stored using one-linkage structures 310-312 when resolving queries using additional levels of indirection is more efficient. Conversely, the edges may be stored using two-linkage structures 314 when resolving queries by filtering a set of edges by additional linkage values is more efficient.

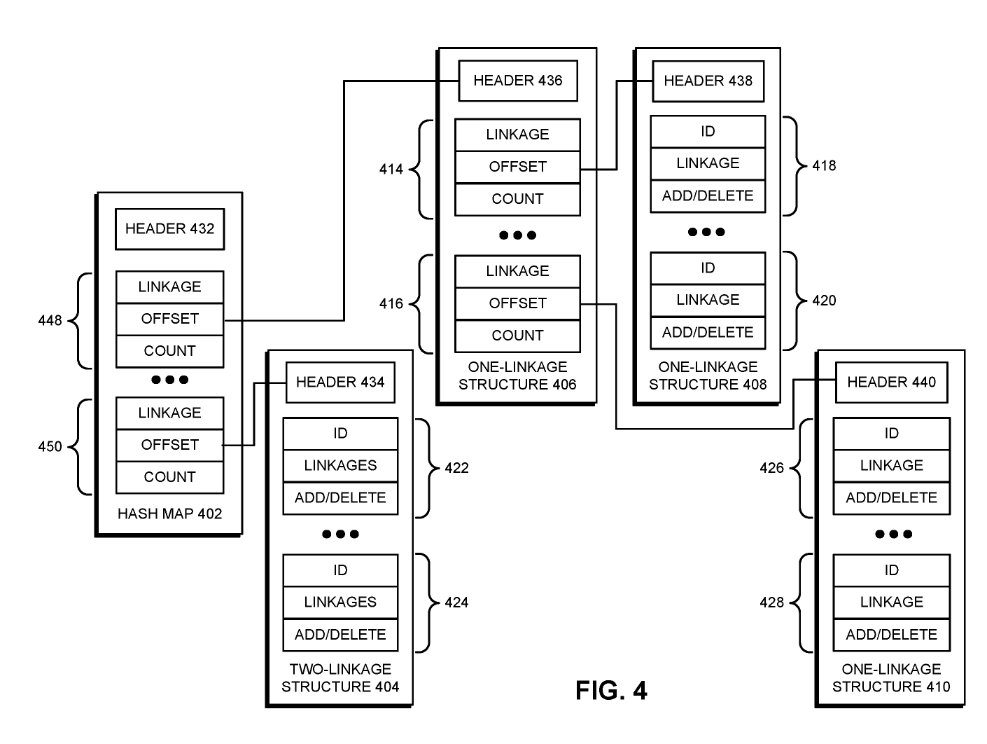

FIG. 4 shows an exemplary index structure for a graph database in accordance with the disclosed embodiments. As shown in FIG. 4, the index structure includes a hash map 402 and an edge store containing a two-linkage structure 404 and three one-linkage structures 406-410.

As mentioned above, queries of the graph database may initially be processed by using lookups of hash map 402 to obtain offsets into the edge store. For example, hash map 402 may be used to perform a lookup by a first linkage type in the graph database, such as a subject in a (subject, predicate, object) triple representing an edge. The linkage type indexed in hash map 402 may be specified in a header 432 for hash map 402. Header 432 may also contain other attributes, such as a numeric version of the index structure, a total size of the hash map, a number of hash buckets in the hash map, a fixed size of the hash buckets, and/or a fixed size of entries in the hash buckets.

Parameters from the queries may be used as keys that are matched to entries 448-450 in hash map 402. For example, a first hash may be applied to a subject value from a query to identify a hash bucket in hash map 402, and a second hash of the subject value may be used to identify a corresponding hash map entry (e.g., entries 448-450) in the hash bucket. The hash map entry may then be read to obtain a linkage, an offset, and a count associated with the subject value. Continuing with the previous example, the linkage may be stored as a hashed value of the subject, the offset may be a memory address in the edge store, and the count may specify the number of edges and/or records in the edge store to which the key maps.

Within the edge store, two-linkage structure 404 and one-linkage structures 406-410 may each contain a header 434-440 and a number of records 414-428. Each record 422-424 in two-linkage structure 404 may store two remaining linkages for an edge with a first linkage that is indexed using hash map 402. On the other hand, records 414-416 of one-linkage structure 406, records 418-420 of one-linkage structure 408, and records 426-428 of one-linkage structure 410 may each store and/or represent one remaining linkage of an edge with a first linkage that is indexed using hash map 402. As a result, a chain of multiple one-linkage structures 406-410 may be used with hash map 402 to resolve edges with three linkages (e.g., a subject, predicate and object).

Headers 434-440 may store information that is used to define and access edges in the corresponding two-linkage structure 404 and one-linkage structures 406-410, respectively. For example, header 434 may identify the first linkage in a set of edges stored in two-linkage structure 404, such as the common subject of the edges. Header 436 may similarly specify the first linkage associated with records 414-416 in one-linkage structure 404. Header 438 may identify a second linkage in a set of edges stored in one-linkage structure 408, and header 440 may identify a separate second linkage in a set of edges stored in one-linkage structure 410. For example, headers 438-440 may specify a predicate shared by edges in the corresponding one-linkage structures 408-410. Headers 434-440 may also store information such as sizes, record counts, and/or other attributes associated with the corresponding two-linkage structure 404 and one-linkage structures 406-410.

After one or more parameters of a query are matched to an entry (e.g., entries 448-450) in hash map 402, the offset may be retrieved from the entry and used to access the edge store. As shown in FIG. 4, the offset stored in entry 448 may reference header 436 and/or a beginning of one-linkage structure 406, and the offset stored in entry 450 may reference header 434 and/or a beginning of two-linkage structure 404. Each referenced offset may be used to access a set of edges matching the key for the corresponding hash map entry.

In particular, the offset stored in entry 450 may be used to access header 434 and records 422-424 in two-linkage structure 404. Records 422-424 may store data that is used to resolve edges containing a first linkage associated with entry 450. For example, two-linkage structure 404 may store edges with the same first linkage that is used as a key to retrieve entry 450 in hash map 402. Each record in two-linkage structure 404 may include an identifier (ID) for an edge with the first linkage, such as an offset in a log-based representation of the graph database at which the edge is written. The record may also include additional linkages that are used to resolve the edge. For example, the record may include values of a predicate, object, and/or other attributes of an edge with a subject that is used as a key to retrieve entry 450 in hash map 402. The record may further include an add/delete indication for the corresponding edge. For example, the add/delete indication may be a bit, flag, and/or other data type that identifies the record as an addition of the edge to the graph database or a deletion of the edge from the graph database. The add/delete indication may thus allow edge additions and edge deletions to be stored in the same edge store structure (e.g., table) instead of in separate edge store structures.

The offset stored in entry 448 may be used to access header 436 and records 414-416 in one-linkage structure 406. Records 414-416 may be associated with edges containing a first linkage associated with entry 448. For example, a common subject associated with records 414-416 may be used as a key for retrieving entry 448 from hash map 402. Unlike records 422-424 of two-linkage structure 404, records 414-416 in one-linkage structure 406 may store data that is similar to entries 448-450 in hash map 420. For example, each record in one-linkage structure 406 may specify a second linkage for edges containing the first linkage, an offset into another one-linkage structure 408-210, and counts of the numbers of edges and/or records in the other one-linkage structure.

The offset stored in record 414 may be used to access one-linkage structure 408, and the offset stored in record 416 may be used to access one-linkage structure 410. For example, the offset stored in record 414 may reference header 438 and/or the beginning of one-linkage structure 408, and the offset stored in record 416 may reference header 440 and/or the beginning of one-linkage structure 410.

One-linkage structure 408 may contain additional records 418-420 for resolving edges containing a first linkage associated with entry 448 and a second linkage associated with record 414. One-linkage structure 410 may contain records 426-428 for resolving edges containing a first linkage associated with entry 448 and a second linkage associated with record 416. Records 418-420 and records 426-428 may each include an ID for an edge containing first and second linkages represented by the corresponding entries 448-450 in hash map 402 and records 414-416 in one-linkage structure 406. Each record in one-linkage structures 408-410 may also include an additional linkage that is used to resolve the corresponding edge. For example, records 418-420 may include values of an object and/or other attribute of edges with a subject that is used as a key to entry 448 in hash map 402 and a predicate that is matched to the linkage stored in record 414. Records 426-428 may include values of an object and/or other attribute of edges with a subject that is used as a key to entry 448 and a predicate that is matched to the linkage stored in record 416. Moreover, records 418-420 and 426-428 may each include an add/delete indication for the corresponding edge.

Those skilled in the art will appreciate that the index may include other types of hash maps, structures, and/or data for facilitating efficient processing of graph database queries. For example, the index may include an additional two-linkage hash map with entries that store offsets into one or more additional one-linkage structures. As a result, the additional two-linkage hash map may be used to resolve, with one less level of indirection than a one-linkage hash map, queries that specify two or more linkages in edges of the graph database. In another example, the index structure may include hash maps and/or structures with more than two linkages for use in processing of queries related to compound relationships and/or other complex structures associated with rules and/or schemas in the graph database. In a third example, sets of edges may be stored in different types and/or combinations of hash maps and linkage structures to balance the overhead associated with filtering edge sets by one or more linkages with the overhead of using multiple hops among the hash maps and linkage structures to resolve the edge sets.

A query of the graph database may be processed by reading and/or writing entries 422-424 in the index structure. For example, a read query may be processed by obtaining one or more edge store offsets from hash map 402 and/or one-linkage structure 406 and producing a result containing linkage values of non-deleted edges from records 422-424, records 418-420, and/or records 426-428 accessed using the edge store offset(s). The result may then be returned in response to the query. In another example, a write query may be processed by linking to one or more edges in two-linkage structure 404 and/or one-linkage structures 408-410 through hash map 402 and/or one-linkage structure 406 and writing IDs, linkages, and/or add/delete indications for the edge(s) to two-linkage structure 404 and/or one-linkage structures 408-410.

In one or more embodiments, the index structure of FIG. 4 is accessed in a lock-free manner by a set of processes. The processes may include a single write process and multiple read processes that map blocks in physical memory in which the hash table and edge store are stored into their respective virtual address spaces. As a result, the processes may access hash buckets, entries, records, and/or other portions of the index structure using offsets in the blocks instead of physical memory addresses.

While writes to the index structure are performed in an append-only manner by the single write process, the read processes may read from the index structure. To ensure that read queries of the graph database produce consistent results, the read processes may process the read queries according to the virtual time at which the read queries were received. As mentioned above, each offset in a log-based representation of the graph database may represent a different virtual time in the graph, and changes in the log up to the offset may be used to establish a state of the graph at the virtual time. A read query may thus be processed by matching the query time of the query (e.g., the time at which the query was received) to the latest offset in the log-based representation at the query time, using hash map 402 and the edge store to access a set of edges matching the query, and generating a result of the query by materializing updates to the edges before the virtual time.

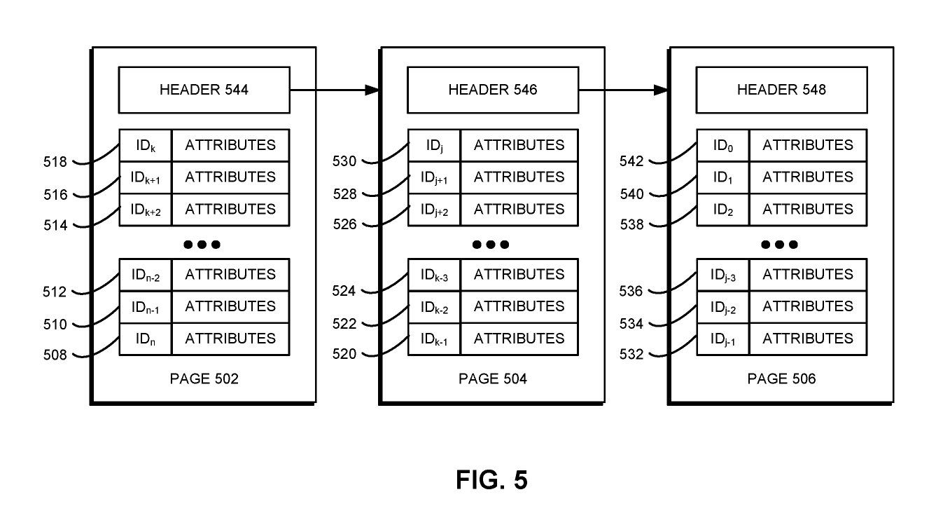

Processing of read queries may further be facilitated using mechanisms for storing, representing, and/or processing deleted edges in the graph database. As shown in FIG. 5, records 508-542 in an edge store may be stored in a series of pages 502-506. Each page may include a header 544-548 that specifies a “page key,” such as a subject, predicate, object, and/or other linkage value that is shared by all edges stored in records 508-542. Headers 544-548 may also specify the sizes, remaining capacities, and/or offsets of the corresponding pages 502-506 in the edge store.

Pages 502-506 may be chained so that page 502 is at the front of the edge store, page 504 is in the middle, and page 506 is at the end. The ordering of pages 502-506 may be specified in a reference (e.g., pointer) to page 504 from header 544 of page 502 and a reference to page 506 from header 546 of page 504. Newer pages may also be placed in front of older pages, so that page 502 is the newest in the edge store, page 504 is the next oldest page in the edge store, and page 506 is the oldest page in the edge store. For example, pages 502-506 may be stored in a “vlist” structure that contains a linked list of arrays. Within the structure, a newly allocated page is stored in an array that is double and/or another multiple of the size of the previous page, and the header and/or beginning of the page may point to the end of the previous page.

Because records 508-542 in the edge store are append-only, the newest record in each page is at the bottom of the page, and the oldest record in the page is at the top of the page. For example, record 508 may be the newest record in the edge store, and record 542 may be the oldest record in the edge store. Edge IDs (e.g., log offsets of edges in the edge store) may be stored in records 508-542 in decreasing order, such that the edge ID of record 508 (e.g., “IDₙ”) is the highest and the edge ID of record 542 (e.g., “ID₀”) is the lowest. Moreover, the edge ID of the first record 518 in page 502 (e.g., “IDₖ”) is higher than the edge ID of the last record 520 in page 504 (e.g., “IDₖ₋₁”), and the edge ID of the first record 530 in page 504 (e.g., “IDⱼ”) is higher than the edge ID of the last record 532 in page 502 (e.g., “IDⱼ₋₁”).

Within records 508-542, edge IDs of the edges may be stored with attributes that are used to resolve queries of the graph database. For example, each record may include one or more linkage values (e.g., subjects, predicates, objects, etc.) and an add/delete indication for the corresponding edge. As a result, the attributes may be used to define edges in the graph database and flag the edges as additions or deletions.

The organization of pages 502-506 and records 508-542 in the edge store may facilitate processing of deleted edges in the graph database. In particular, the ordering of records 508-542 and pages 502-506 may enable traversal of the edge store in order of decreasing edge ID. During such traversal of the edge store, a set of deleted edges is generated. For example, the set of deleted edges may be produced by adding each record that is identified as a deletion to a temporary hash set that is indexed by one or more linkage types in records 508-542. Each record representing an added edge may then be compared against the deleted edges, so that only edges that have not been deleted are materialized in an edge set associated with the edge store. Continuing with the previous example, a record that is identified as an edge addition in the traversal may be added to a result set for a query of the graph database only if a corresponding deletion with the same linkage values as the addition is not found in the set of deleted edges.

To further expedite processing of deleted edges, additional attributes may be stored in records 508-542, headers 544-548, and/or other parts of the edge store and/or a hash map referencing the edge store. For example, each header may include a bit, flag, and/or other data type indicating whether the corresponding page contains any edge deletions. If the header indicates that the page does not contain edge deletions, processing of deleted edges may be omitted for the page. In another example, the bit, flag, and/or data type may be stored in a hash map entry and/or edge store record with an offset that references the edge store. If the entry and/or record indicates that the edge store does not contain edge deletions, processing of deleted edges may be omitted for all pages 502-506. In a third example, each record 508-542 representing an edge addition may include a bit, flag, and/or other data type indicating if the corresponding edge has been subsequently deleted. As a result, the record may be checked against the deleted edge set only when the edge is indicated to have been deleted.

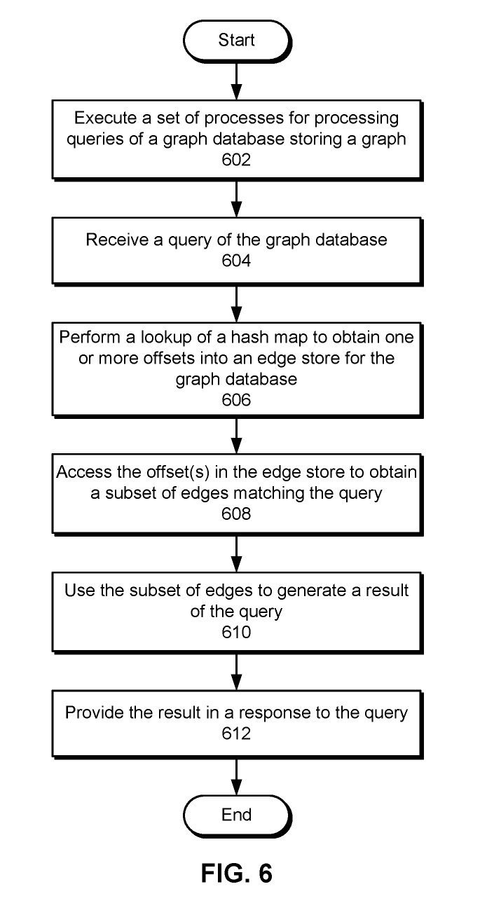

FIG. 6 shows a flowchart illustrating the process of providing an index to a graph database in accordance with the disclosed embodiments. In one or more embodiments, one or more of the steps may be omitted, repeated, and/or performed in a different order. Accordingly, the specific arrangement of steps shown in FIG. 6 should not be construed as limiting the scope of the technique.

Initially, a set of processes for processing queries of a graph database storing a graph is executed (operation 602). The processes may include a single write process and multiple read processes that access the graph database and/or an index structure for the graph database in a lock-free manner. The graph may include a set of nodes, a set of edges between pairs of nodes, and a set of predicates. Next, a query of the graph database is received (operation 604). For example, the query may be used to read and/or write one or more edges in the graph database.

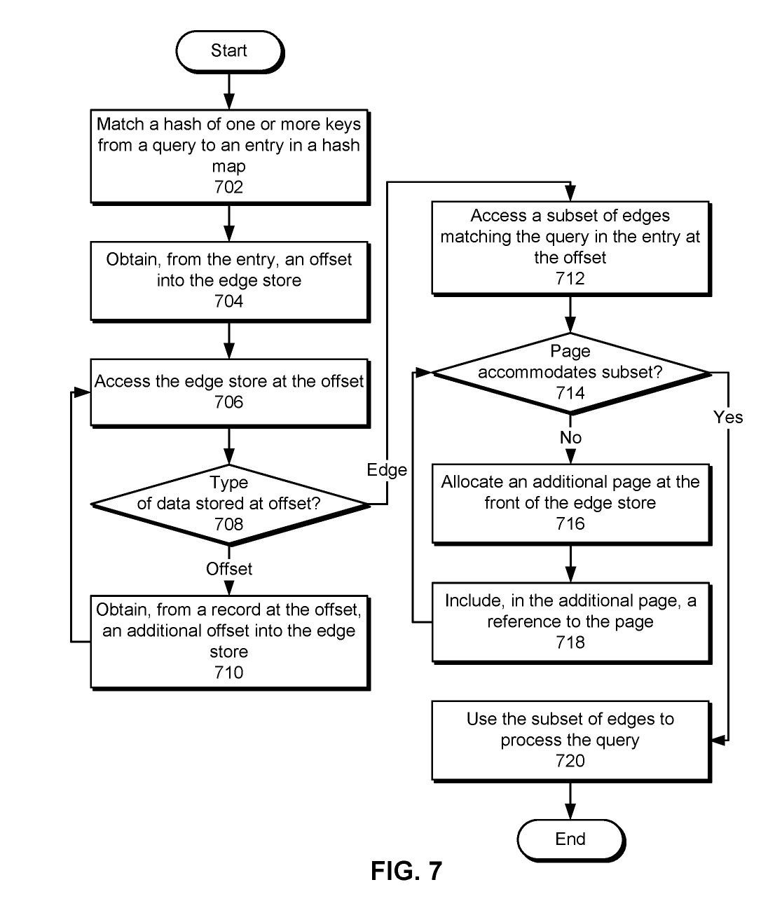

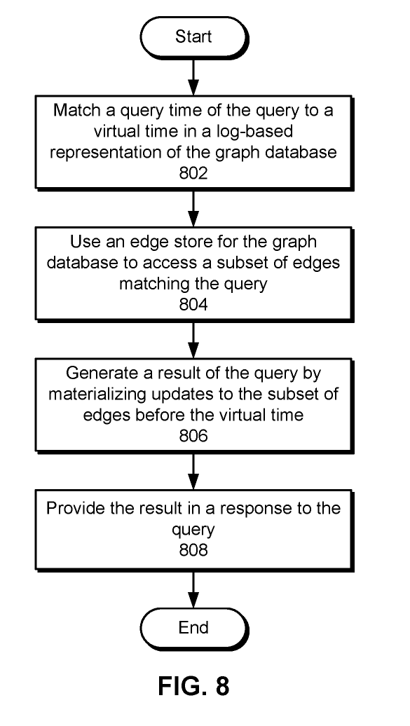

The query may be processed by one or more of the processes. First, a lookup of a hash map is performed to obtain one or more offsets into an edge store for the graph database (operation 606). The offset(s) are accessed to obtain a subset of edges matching the query (operation 608), as described in further detail below with respect to FIG. 7. The subset of edges is then used to generate a result of the query (operation 610), as described in further detail below with respect to FIG. 8.

Finally, the result is provided in a response to the query (operation 612). For example, the result may include the subset of edges matching one or more parameters of a read query. In another example, the result may include a processing status (e.g., successful, unsuccessful, etc.) associated with processing a write query that writes the subset of edges to the graph database, hash map, and/or edge store.

FIG. 7 shows a flowchart illustrating the process of accessing an edge store for a graph database in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the technique.

First, a hash of one or more keys from a query is matched to an entry in a hash map (operation 702). For example, a first hash of a subject, predicate, object, and/or other linkage associated with edges in a graph may be mapped to a hash bucket in the hash map, and a second hash of the linkage may be mapped to an entry in the hash bucket. Next, an offset into the edge store is obtained from the entry (operation 704), and the edge store is accessed at the offset (operation 706). For example, the offset may be used to read and/or write data stored at the offset.

Subsequent access to the edge store may depend on the type of data stored at the offset (operation 708). If a record at the offset stores an edge, a subset of edges matching the query is accessed at the offset (operation 712). For example, edge data that is directly referenced by the hash map may include one or more offsets (e.g., edge IDs) of the subset of the edges in a log-based representation of the graph database, one or more additional linkages for resolving the subset of the edges, and/or an add/delete indication.

If a record at the offset stores an additional offset into the edge store, the additional offset is obtained from the record (operation 710), and the edge store is accessed at the additional offset (operation 706). The additional offset may be stored with a linkage for edges in the edge store. For example, the additional offset may be stored with a second linkage shared by edges at the offset, which in turn is accessed using a hash of a first linkage shared by the same edges. Operations 706-710 may be repeated until the type of data stored at a referenced offset is an edge. In turn, records at the referenced offset may include one or more offsets of the subset of the edges in the log-based representation, remaining linkages for resolving the subset of the edges, and the add/delete indication. Once an edge is found at the offset, a subset of edges matching the query is accessed at the offset (operation 712). For example, the offset may be used to read and/or write records storing the subset of edges in the edge store.

The query may then be processed based on the ability of a page in the edge store to accommodate the subset of edges (operation 714). For example, the page may accommodate a read query that reads one or more existing edges from the page and/or other pages in the edge store. On the other hand, the page may be unable to accommodate a write query that writes one or more new edges to the page if the remaining capacity of the page is not sufficient to store the new edges.

If the page can accommodate the subset of edges, the subset of edges is used to process the query (operation 720). For example, the query may be processed by reading and/or writing the subset of edges in the page. If the page cannot accommodate the subset of edges, an additional page is allocated at the front of the edge store (operation 716), and a reference to the page is included in the additional page (operation 718). Operations 716-718 may be repeated until pages in the edge store can accommodate the subset of edges in the query. After one or more additional pages are allocated and configured to reference older pages in the edge store, the subset of edges is written to the allocated page(s) and/or otherwise used to process the query (operation 720).

FIG. 8 shows a flowchart illustrating the processing of a query of a graph database in accordance with the disclosed embodiments. In one or more embodiments, one or more of the steps may be omitted, repeated, and/or performed in a different order. Accordingly, the specific arrangement of steps shown in FIG. 8 should not be construed as limiting the scope of the technique.

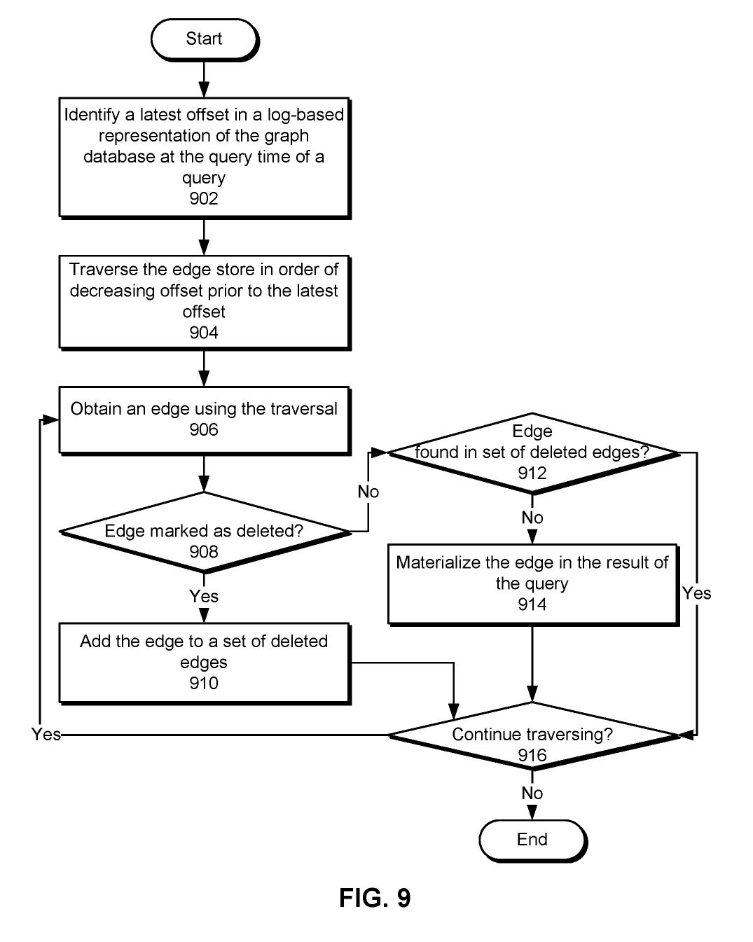

Initially, a query time of the query is matched to a virtual time in a log-based representation of the graph database (operation 802). For example, the time at which the query was received may be matched to a latest offset in the log-based representation. Next, an edge store for the graph database is used to access a subset of edges matching the query (operation 804), as described above. A result of the query is then generated by materializing updates to the subset of edges before the virtual time (operation 806), as described in further detail below with respect to FIG. 9. Finally, the result is provided in a response to the query (operation 808).

FIG. 9 shows a flowchart illustrating the process of using an edge store of a graph database to resolve a query of the graph database in accordance with the disclosed embodiments. In one or more embodiments, one or more of the steps may be omitted, repeated, and/or performed in a different order. Accordingly, the specific arrangement of steps shown in FIG. 9 should not be construed as limiting the scope of the technique.

First, a latest offset in a log-based representation of the graph database at the query time of the query is identified (operation 902). For example, the latest offset may be obtained as the number of bytes separating the last entry in the log-based representation from the beginning of the log-based representation at the time at which the query was received. Next, the edge store is traversed in order of decreasing offset in the log-based representation prior to the latest offset (operation 904) at the query time. For example, the traversal may be performed by reading records from pages in the edge store in reverse order, starting with the highest offset prior to the latest offset and proceeding until the oldest record in a linked list of pages in the edge store is reached.

As the traversal is performed, updates to edges in the edge store are applied to produce a result of the query. In particular, an edge is obtained (operation 906) from the edge store during the traversal. For example, the edge may be stored in a record that includes the edge's offset in the log-based representation, one or more linkage values for the edge, and an add/delete indication. The edge may be processed based on marking of the edge as deleted (operation 908). Continuing with the previous example, the edge may be marked as deleted or added in a flag or bit providing the add/delete indication. If the edge is marked as deleted, the edge is added to a set of deleted edges (operation 910). For example, the edge may be added to a temporary hash set for tracking deleted edges in the edge store.

If the edge is not marked as deleted, the edge may be checked against the set of deleted edges to determine if the edge is found in the set (operation 912). If the edge is not found in the set of deleted edges, the edge is materialized in the result of the query (operation 914). For example, the offset, linkages, and/or other attributes of the edge may be included in the result. If the edge is found in the set of deleted edges, the edge is not materialized in (i.e., it is omitted from) the result.

Operations 906-914 may be repeated while during traversal of the edge store in order of decreasing offset (operation 916). Each deleted edge obtained in the traversal may be added to the set of deleted edges (operations 908-910), and each added edge may be materialized or not materialized in the query's result based on the presence or absence of the edge in the set of deleted edges (operations 912-914). Such processing of edges in the edge store may continue until the traversal is complete.

Alternatively, operations 906-914 may be omitted for some or all edges in the edge store. For example, generation of the set of deleted edges and/or comparison of added edges against the set of deleted edges may be performed only for pages, edges, and/or other components of the edge store that have been flagged as having deleted edges. If the components are not indicated as having deleted edges, updates to edges in the components may be included in the result of the query, up to the virtual time corresponding to the query time of the query. In another example, an added edge may be checked against the set of deleted edges only when the edge is associated with a flag, bit, and/or other indication that the edge has been subsequently deleted.

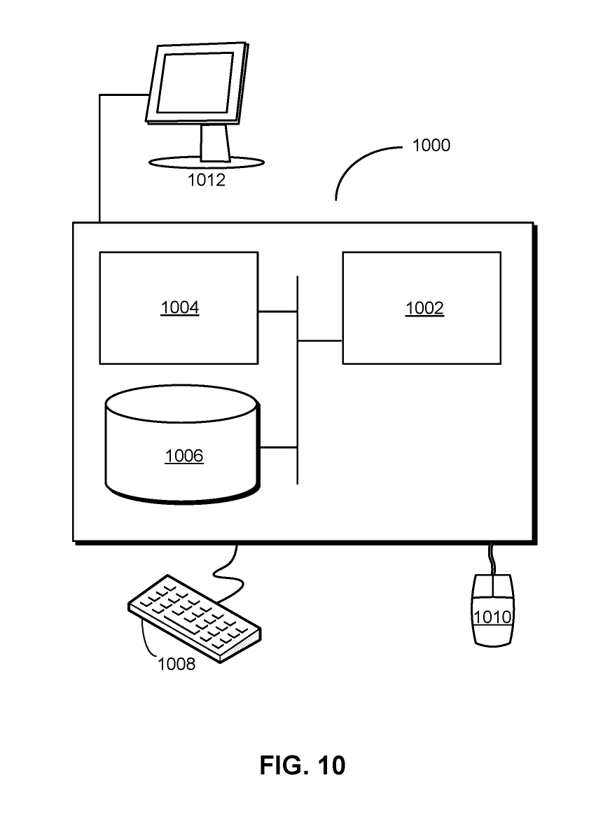

FIG. 10 shows a computer system 1000 in accordance with the disclosed embodiments. Computer system 1000 includes a processor 1002, memory 1004, storage 1006, and/or other components found in electronic computing devices. Processor 1002 may support parallel processing and/or multi-threaded operation with other processors in computer system 1000. Computer system 1000 may also include input/output (I/O) devices such as a keyboard 1008, a mouse 1010, and a display 1012.

Computer system 1000 may include functionality to execute various components of the disclosed embodiments. In particular, computer system 1000 may include an operating system (not shown) that coordinates the use of hardware and software resources on computer system 1000, as well as one or more applications that perform specialized tasks for the user. To perform tasks for the user, applications may obtain the use of hardware resources on computer system 1000 from the operating system, as well as interact with the user through a hardware and/or software framework provided by the operating system.

In one or more embodiments, computer system 1000 provides a system for processing queries of a graph database. The system includes a set of processes, which may include a single write process and multiple read processes. When a query of the graph database is received, one or more of the processes may process the query by performing a lookup of a hash map to obtain one or more offsets into an edge store for the graph database. The edge store may include a one-linkage structure and a two-linkage structure for indexing and/or storing edges in the graph database. Next, the process(es) may access the offset(s) in the edge store to obtain a subset of the edges matching the query. The process(es) may then use the subset of the edges to generate a result of the query. Finally, the process(es) may provide the result in a response to the query.

To generate the result, the process(es) may materialize updates to the subset of edges before a virtual time in a log-based representation of the graph database that represents a query time of the query. In particular, the process(es) may traverse the edge store in order of decreasing offset in the log-based representation to obtain updates to the subset of the edges before the virtual time. The process(es) may then apply the updates to the subset of the edges to produce the result. For example, the process(es) may generate a set of deleted edges during the traversal. The process(es) may also check an addition of an edge in the edge store against the set of deleted edges. The process(es) may then materialize the edge in the result when the edge is not found in the set of deleted edges.

In addition, one or more components of computer system 1000 may be remotely located and connected to the other components over a network. Portions of the present embodiments (e.g., hash map, edge store, log-based representation, processes, etc.) may also be located on different nodes of a distributed system that implements the embodiments. For example, the present embodiments may be implemented using a cloud computing system that processes queries of a distributed graph database from a set of remote users and/or clients.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method, comprising:
executing a set of processes for processing queries of a graph database storing a graph, wherein the graph comprises a set of nodes, a set of edges between pairs of nodes in the set of nodes, and a set of predicates; and
when a query of the graph database is received, using one or more of the processes to process the query by:
performing a lookup of a hash map to obtain one or more offsets into an edge store for the graph database, wherein the edge store comprises a one-linkage structure and a two-linkage structure;
accessing the one or more offsets in the edge store to obtain a subset of the edges matching the query;
using the subset of the edges to generate a result of the query; and
providing the result in a response to the query.

2. The method of claim 1, wherein accessing the one or more offsets into the edge store to obtain the subset of edges matching the query comprises:
obtaining, from the lookup of the index, a first offset in the edge store; and
using the first offset in the edge store to access the subset of the edges matching the query in the edge store.

3. The method of claim 2, wherein using the first offset in the edge store to access the subset of the edges matching the query in the edge store comprises:
obtaining, from a record at the first offset in a first one-linkage structure in the edge store, a second offset in a second one-linkage structure in the edge store; and
accessing the subset of the edges at the second offset in the second one-linkage structure.

4. The method of claim 3, wherein the first one-linkage structure comprises:
a second linkage associated with the second one-linkage structure; and
the second offset.

5. The method of claim 4, wherein the second one-linkage structure comprises:
one or more offsets of the subset of the edges in a log-based representation of the graph database;
a third linkage for the subset of the edges; and
an add/delete indication.

6. The method of claim 2, wherein using the first offset in the edge store to access the subset of the edges matching the query in the edge store comprises:
accessing the subset of the edges at the first offset in a two-linkage structure in the edge store.

7. The method of claim 6, wherein the two-linkage structure comprises:
one or more offsets of the subset of the edges in a log-based representation of the graph database;
one or more additional linkages for the subset of the edges; and
an add/delete indication.

8. The method of claim 1, wherein using the subset of the edges to generate the result of the query comprises:
upon determining that a page in the edge store cannot accommodate an edge in the subset of the edges:
allocating an additional page at a front of the edge store;
writing the edge to the additional page; and
including, in the additional page, a reference to the page.

9. The method of claim 1, wherein performing the lookup of the hash map comprises:
matching a hash of one or more keys from the query to a hash map entry in the hash map; and
obtaining, from the hash map entry, an offset into the edge store.

10. The method of claim 1, wherein the edges in the edge store are stored in order of increasing offset in a log-based representation of the graph database.

11. The method of claim 1, wherein the subset of the edges comprises:
a subject;
a predicate;
an object; and
an offset.

12. An apparatus, comprising:
one or more processors; and
memory storing instructions that, when executed by the one or more processors, cause the apparatus to:
execute a set of processes for processing queries of a graph database storing a graph, wherein the graph comprises a set of nodes, a set of edges between pairs of nodes in the set of nodes, and a set of predicates; and
when a query of the graph database is received, use one or more of the processes to process the query by:
performing a lookup of a hash map to obtain one or more offsets into an edge store for the graph database, wherein the edge store comprises a one-linkage structure and a two-linkage structure; and
accessing the one or more offsets in the edge store to obtain a subset of the edges matching the query;
using the subset of the edges to generate a result of the query; and
providing the result in a response to the query.

13. The apparatus of claim 12, wherein accessing the one or more offsets into the edge store to obtain the subset of edges matching the query comprises:
obtaining, from the lookup of the index, a first offset in the edge store; and
using the first offset in the edge store to access the subset of the edges matching the query in the edge store.

14. The apparatus of claim 13, wherein using the first offset in the edge store to access the subset of the edges matching the query in the edge store comprises:
obtaining, from a record at the first offset in a first one-linkage structure in the edge store, a second offset in a second one-linkage structure in the edge store; and
accessing the subset of the edges at the second offset in the second one-linkage structure.

15. The apparatus of claim 13, wherein using the first offset in the edge store to access the subset of the edges matching the query in the edge store comprises:
accessing the subset of the edges at the first offset in a two-linkage structure in the edge store.

16. The apparatus of claim 12, wherein using the subset of the edges to generate the result of the query comprises:
upon determining that a page in the edge store cannot accommodate an edge in the subset of the edges:
allocating an additional page at a front of the edge store;
writing the edge to the additional page; and
including, in the additional page, a reference to the page.

17. The apparatus of claim 12, wherein performing the lookup of the hash map comprises:
matching a hash of one or more keys from the query to a hash map entry in the hash map; and
obtaining, from the hash map entry, an offset into the edge store.

18. The apparatus of claim 12, wherein the edges in the edge store are stored in order of increasing offset in a log-based representation of the graph database.

19. A system, comprising:
a management module comprising a non-transitory computer-readable medium comprising instructions that, when executed, cause the system to execute a set of processes for processing queries of a graph database storing a graph, wherein the graph comprises a set of nodes, a set of edges between pairs of nodes in the set of nodes, and a set of predicates; and
a processing module comprising a non-transitory computer-readable medium comprising instructions that, when executed, cause the system to use one or more of the processes to process the query by:
performing a lookup of a hash map to obtain one or more offsets into an edge store for the graph database, wherein the edge store comprises a one-linkage structure and a two-linkage structure; and
accessing the one or more offsets in the edge store to obtain a subset of the edges matching the query;
using the subset of the edges to generate a result of the query; and
providing the result in a response to the query

20. The system of claim 19, wherein accessing the one or more offsets into the edge store to obtain the subset of edges matching the query comprises:
obtaining, from the lookup of the index, a first offset in the edge store; and
using the first offset in the edge store to access the subset of the edges matching the query in the edge store.
